(19) United States
(12) Patent Application Publication
(10) Pub. No.: US 2002/0133950 A1
(43) Pub. Date: Sep. 26, 2002

(54) Hole misalignment compensation system and method

(75) Inventor: Roy P. Bullard, Fort Worth, TX (US)

Correspondence Address: Harold E. Meier, Esq., Baker Botts L.L.P., 2001 Ross Avenue, Dallas, TX, 75201-2980, US

(73) Assignee: Lockheed Martin Corporation

(21) Appl. No.: 09/818,340

(22) Filed: Mar. 26, 2001

(51) Int. Cl. B23P 11/00; F16C 23/04

(52) U.S. Cl. 29/898.07; 384/192

(57) ABSTRACT

According to one embodiment of the invention, a hole misalignment compensation system includes an outer bushing having a first outside diameter approximately equal to a diameter of a first hole in a first part and a first inside diameter eccentric to the first outside diameter, and an inner bushing having a second outside diameter approximately equal to the first inside diameter and a second inside diameter eccentric to the second outside diameter. The inner bushing is adapted to be positioned such that an axis of the second inner diameter approximately aligns with an axis of a second hole in a second part.

### TECHNICAL FIELD OF THE INVENTION

This invention relates generally to the field of structural joining and, more specifically, to a hole misalignment compensation system and method.

### BACKGROUND OF THE INVENTION

There are a myriad of systems and methods to join structural members. For example, a hole can be drilled in each of two structural members and then a fastener, such as a bolt with a nut, can be used to join the structural members. Depending on the application for the structural members, numerous design considerations such as stress, strain, and fatigue determines the proper fastener size and type, hole size, and tolerances. Moreover, structural members typically require numerous fasteners to join them together. When each structural member is fabricated separately then the holes most often are misaligned. Misalignment of holes can cause numerous problems. One problem is that significant re-work is needed to correct the misalignment of the holes. In fact, if two sets of holes exist in a set of structural parts, then one set of holes can have a misalignment in one direction while the other set of holes has a misalignment in another direction. Compensating for these misalignments can cause significant delays in lead times and can result in significant labor costs to fix the problem. Therefore, structural member fabricators desire cost-effective and time saving systems or methods to compensate for hole misalignment.

Various systems and methods are used to compensate for hole misalignment, one such method being that a smaller bolt is used in place of the originally designed one. However, this could lead to disastrous results from a structural standpoint because of potential fatigue failure and stress failure. Another method to compensate for hole misalignment is to try to avoid the misalignment. However, various methods in both the design and manufacturing stages to ensure precise positional hole tolerances can result in significant added costs and wasted time. Another system utilized is a machine that essentially re-drills the correct size hole through both structural members. This re-drilling is very expensive because of the required labor. Some structural fabricators use solid bushings in one of the holes and then re-drill the hole from the other side. Once again, this is very expensive and time consuming.

### SUMMARY OF THE INVENTION

The challenges in the field of structural joining continue to increase with demands for more and better techniques having greater flexibility and adaptability. Therefore, a need has arisen for a new hole misalignment compensation system and method.

In accordance with the present invention, a hole misalignment compensation system and method are provided that address disadvantages and problems associated with previously developed systems and methods.

According to one embodiment of the invention, a hole misalignment compensation system includes an outer bushing having a first outside diameter approximately equal to a diameter of a first hole in a first part and a first inside diameter eccentric to the first outside diameter, and an inner bushing having a second outside diameter approximately equal to the first inside diameter and a second inside diameter eccentric to the second outside diameter. The inner bushing is adapted to be positioned such that an axis of the second inner diameter approximately aligns with an axis of a second hole in a second part.

According to another embodiment of the invention, a hole misalignment compensation method includes disposing an outer bushing within a first hole of a first part, the outer bushing having a first outside diameter approximately equal to a diameter of the first hole and a first inside diameter eccentric to the first outside diameter, disposing an inner bushing within the outer bushing, the inner bushing having a second outside diameter approximately equal to the first inside diameter and a second inside diameter eccentric to the second outside diameter, and positioning the inner bushing such that an axis of the second inner diameter approximately aligns with an axis of a second hole of a second part.

Embodiments of the invention provide numerous technical advantages. For example, one embodiment of the present invention allows the position of mating holes to have some coaxial misalignment while maintaining functionality. This flexibility provides significant cost savings at both the detail fabrication level and the assembly level. Another embodiment of the present invention provides reduced process times for assemblies based on the elimination of the need for material removal during the assembly process, and based on the elimination of time-consuming, hand fitting operations. Reducing process times for assemblies, while maintaining or improving quality, reduces cost and improves customer satisfaction.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is an elevation view of a pair of holes in a first structural part misaligned with a pair of holes in a second structural part according to one embodiment of the present invention;

FIG. 2A is an exploded, perspective view showing outer and inner bushings utilized to compensate for the misalignment of a hole in the first structural part of FIG. 1 with a hole in the second structural part of FIG. 1 according to one embodiment of the present invention;

FIG. 2B is a cross-section of the outer bushing of FIG. 2A;

FIG. 2C is a cross-section of the inner bushing of FIG. 2A;

FIGS. 3A and 3B are elevation and cross-sectional views, respectively, showing the outer bushing of FIG. 2A installed in a hole of the first structural part of FIG. 1 and the inner bushing of FIG. 2A installed in the outer bushing. FIGS. 3A and 3B illustrate the axis of the inside diameter of the inner bushing misaligned with the axis of a hole in the second structural part of FIG. 1;

FIGS. 4A and 4B are elevation and cross-sectional views, respectively, showing the outer and inner bushings of FIGS. 3A and 3B rotated within the hole of the first structural part such that the axis of the inside diameter of the inner bushing aligns with the axis of the hole in the second structural part;

FIG. 5 is a perspective view of an alternative embodiment of the present invention showing a bolt having an eccentric lobe for use as an alternative to the inner bushing; and

FIG. 6 is a flowchart demonstrating a hole misalignment compensation method in accordance with one embodiment of the present invention.

### DETAILED DESCRIPTION OF EMBODIMENTS OF THE INVENTION

Embodiments of the present invention and their advantages are best understood by referring now to FIGS. 1-6 of the drawings, in which like numerals refer to like parts.

FIG. 1 is an elevation view of a plurality of holes 101 in a structural part 100 misaligned with a plurality of holes 103 in a structural part 102 according to one embodiment of the present invention. Structural part 100 and structural part 102 may be any suitable structural parts used in any industry, such as the aeronautic, automotive, and structural fabrication industry. In addition, structural part 100 and structural part 102 may be formed from any suitable material.

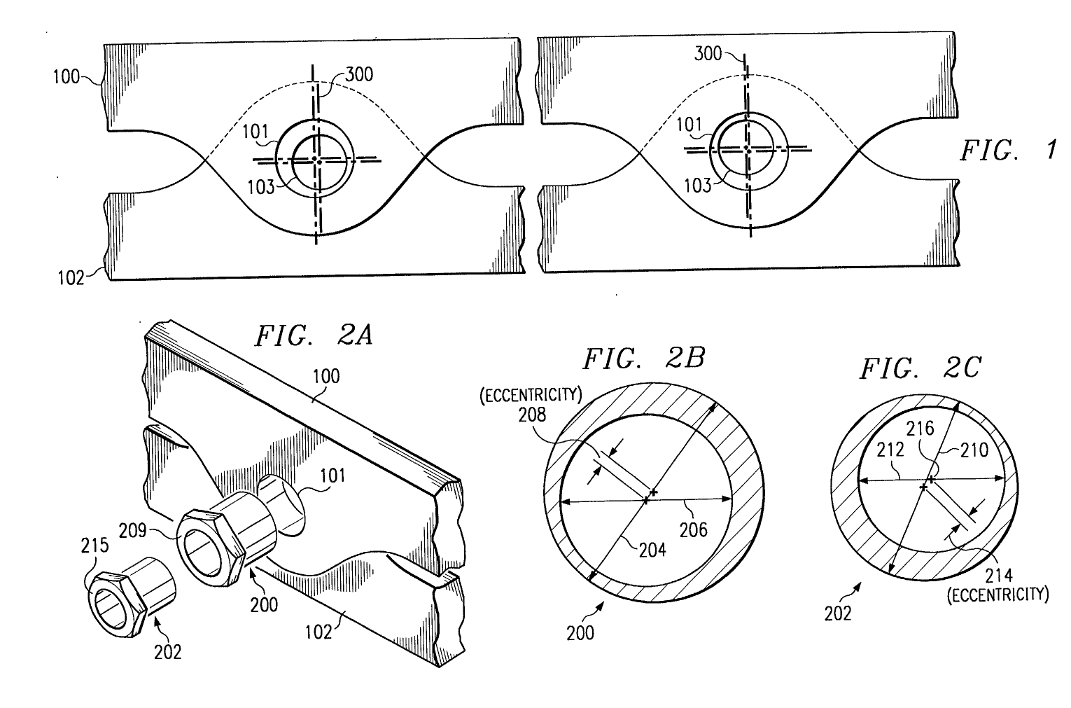

Holes 101 and holes 103 facilitate the joining of structural part 100 and structural part 102. Holes 101 and holes 103 are shown in FIG. 1 as being formed with different diameters to accommodate the teachings of the present invention as described more fully below. However, holes formed in structural parts that are to be joined are typically formed with the same diameter, which leads to many problems. For example, severe tolerance problems can arise if two structural parts are formed in separate stages. Furthermore, if structural parts are to be joined in a plurality of places then one or more sets of holes can be misaligned and these misalignments can be in any direction. Inserting a fastener, such as a bolt, in two misaligned holes can lead to disastrous results. For example, depending on the particular application, efficient load transfer will not occur, which can lead to excessive wear, fatigue problems, and premature failure. Accordingly, if holes formed in structural members are misaligned, then significant re-work or other systems and methods must be employed to correct the problem. These various systems and methods are a huge waste of time and money. Therefore, the present invention compensates for hole misalignments by providing, in one embodiment, an outer bushing 200 and an inner bushing 202 as shown in FIGS. 2A through 4B below.

FIG. 2A is an exploded, perspective view showing outer bushing 200 and inner bushing 202 utilized to compensate for misalignment of hole 101 in structural part 100 and hole 103 in structural part 102 according to one embodiment of the present invention. Only two bushings are shown in FIG. 2A; however, more than two may be used within the spirit and scope of the present invention.

Referring to FIGS. 2A and 2B, outer bushing 200, in one embodiment, is a cylindrical bushing having an outside diameter 204 and an inside diameter 206 that is eccentric to outside diameter 204. The eccentricity of outside diameter 204 and inside diameter 206 is denoted by reference numeral 208. In one embodiment, outside diameter 204 is approximately equal to a diameter of hole 101 in structural part 100; however, outside diameter 204 may be any suitable diameter. Inside diameter 206 is any suitable diameter that is determined by design and manufacturing criteria. Eccentricity 208 is any suitable eccentricity depending on the diameters of hole 101 and hole 103 and the misalignment expected to occur in fabricating holes 101 in structural part 100 and holes 103 in structural part 102. Outer bushing 200 may be any suitable length; however, in one embodiment, outer bushing 200 has a length approximately equal to the length of hole 101 in structural part 100. Outer bushing 200 may also include a head 209 as shown in FIG. 2A. In one embodiment, head 209 is a hex head; however, head 209 may be other suitable heads that facilitate a rotation of outer bushing 200. In one embodiment, outer bushing 200 is formed from a metal; however, outer bushing 200 may be formed from any suitable material.

Referring to FIGS. 2A and 2C, inner bushing 202, in one embodiment, has an outside diameter 210 and an inside diameter 212 that is eccentric to outside diameter 210. The eccentricity of outside diameter 210 and inside diameter 212 is denoted by reference numeral 214. In one embodiment, outside diameter 210 is approximately equal to inside diameter 206 of outer bushing 200; however, outside diameter 210 may be any suitable diameter. In one embodiment, inside diameter 212 is approximately equal to a diameter of hole 103 in structural part 102; however, inside diameter 212 may be any suitable diameter, which is determined by design and manufacturing criteria. Eccentricity 214 is any suitable eccentricity depending on the diameters of hole 101 and hole 103 and the misalignment expected to occur in fabricating holes 101 in structural part 100 and holes 103 in structural part 102. Inner bushing 202 is any suitable length; however, in one embodiment, a length of inner bushing 202 is approximately equal to a length of hole 101 in structural part 100 plus the length of any included head 209. Similar to outer bushing 200, inner bushing 202 may include a head 215. In one embodiment, head 215 is a hex head; however, head 215 may be other suitable heads that facilitate a rotation of inner bushing 202. In one embodiment, inner bushing 202 is formed from a metal; however, inner bushing 202 may be formed from other suitable materials.

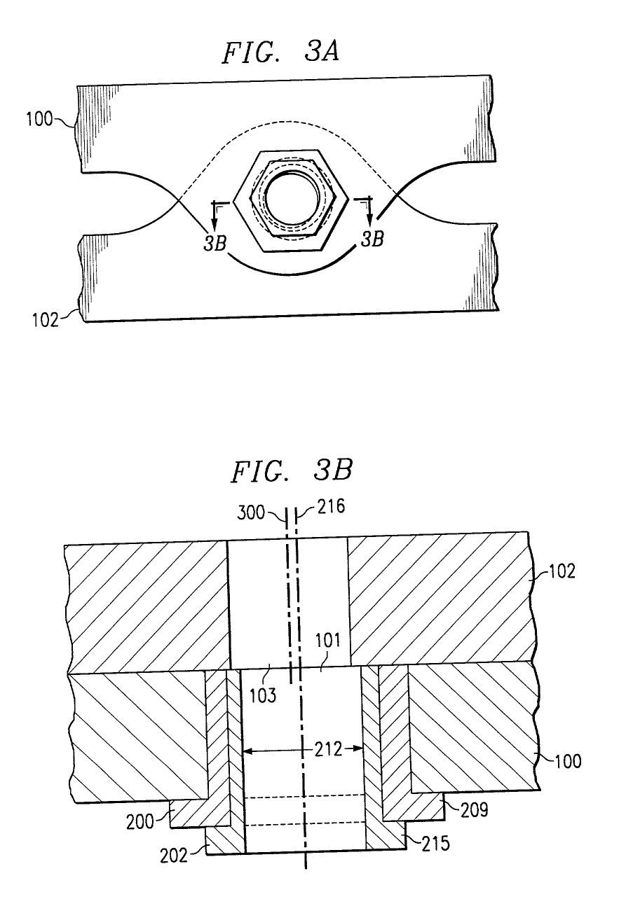

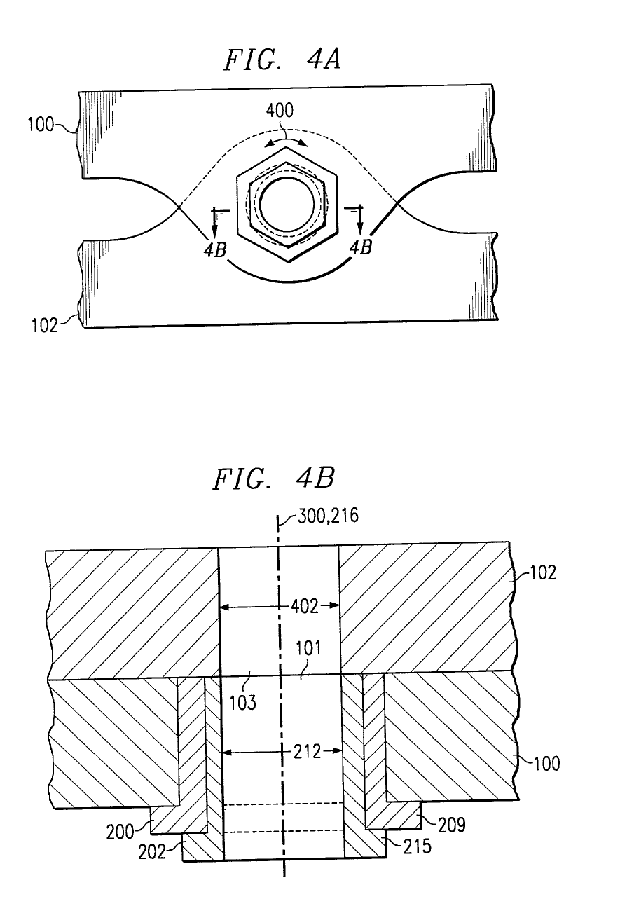

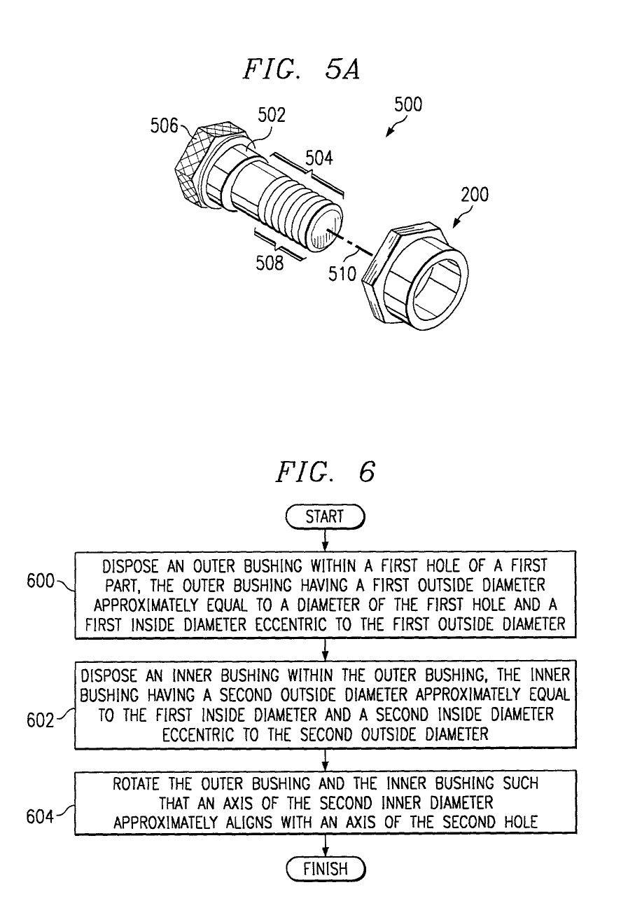

According to the teachings of the present invention, outer bushing 200 and inner bushing 202 are adapted to be positioned such that an axis 216 of inner diameter 212 of inner bushing 202 approximately aligns with an axis 300 (FIG. 3B) of hole 103 in structural part 102. The utilization of outer bushing 200 and inner bushing 202 to compensate for misalignment of holes 101 and holes 103 is illustrated below in conjunction with FIGS. 3A through 4B.

FIGS. 3A and 3B are elevation and cross-sectional views, respectively, showing outer bushing 200 installed in hole 101 of structural part 100 and inner bushing 202 installed in outer bushing 200. As illustrated, axis 216 of inside diameter 212 of inner bushing 202 is misaligned with axis 300 of hole 103 in structural part 102. Since a fastener, such as a bolt or pin, is utilized to join structural part 100 and structural part 102, having axis 216 approximately aligned with axis 300 is advantageous. This alignment facilitates a snug fit of any fastener that joins structural part 100 and structural part 102, and causes stress and strain that is encountered in service to be correctly distributed. In addition, structural part failure due to fatigue may be significantly reduced or eliminated.

According to the teachings of the present invention, outer bushing 200 and inner bushing 202 have eccentricities 208 and 214 that facilitate the alignment of axis 216 and axis 300. In one embodiment, eccentricity 208 of inside diameter 206 of outer bushing 200 plus eccentricity 214 of inside diameter 212 of inner bushing 202 is no less than the misalignment of an axis 302 of hole 101 and axis 300 of hole 103. For example, if there is a misalignment of hole 101 and hole 103 of 0.06 inches, then inside diameter 206 of outer bushing 200 and inside diameter 212 of inner bushing 202 have eccentricities 208 and 214 of not less than 0.03 inches. In this way, axis 216 of inside diameter 212 is positioned anywhere on, or within, a circle having a radius of 0.06 inches, but only up to 0.06 inches. Accordingly, no matter what direction hole 103 is misaligned with hole 101, axis 216 can approximately align with axis 300.

FIGS. 4A and 4B are elevation and cross-sectional views, respectively, showing outer bushing 200 rotated within hole 101 of structural part 100 and inner bushing 202 rotated within outer bushing 200 such that axis 216 of inside diameter 212 aligns with axis 300 of hole 103 in structural part 102. The rotation of outer bushing 200 and inner bushing 202 is illustrated by reference numeral 400 as shown in FIG. 4A. In one embodiment, only inner bushing 202 is rotated such that axis 216 approximately aligns with axis 300. Alternatively, only outer bushing 200 is rotated such that axis 216 approximately aligns with axis 300.

As shown in FIG. 4B, inside diameter 212 of inner bushing 202 and a diameter 402 of hole 103 approximately match; however, as mentioned previously, inside diameter 212 of inner bushing 202 may be different than diameter 402 of hole 103. In such a case, a stepped fastener is used to join structural part 100 and structural part 102.

The use of outer bushing 200 and inner bushing 202 substantially reduces or eliminates any misalignment problems of holes 101 in structural part 100 and holes 103 in structural part 102. Outer bushing 200 and inner bushing 202 substantially reduces or eliminates any re-work necessary to correct any misalignment of holes 101 in structural part 100 and holes 103 in structural part 102, which saves considerable time and money.

FIG. 5 is a perspective view of an alternative embodiment of the present invention showing an inner member 500 for use as an alternative to inner bushing 202. Inner member 500 has a first cylindrical portion 502 and a second cylindrical portion 504 eccentric to first cylindrical portion 502. First cylindrical portion 502 serves the same function of outside diameter 210 of inner bushing 202 and second cylindrical portion 504 functions as a fastener for structural part 100 and structural part 102.

In one embodiment, inner member 500 serves as a bolt having a head 506 and a threaded portion 508, wherein head 506 is substantially coaxial with an axis 510 of second cylindrical portion 504; however, inner member 500 may be any suitable member adapted to be positioned such that axis 510 of second cylindrical portion 504 approximately aligns with axis 300 of hole 103 in structural part 102. In one embodiment, head 506 is a knurled surface as illustrated in FIG. 5; however, head 506 may be a hex head or other head suitable for rotating inner member 500. Inner member 500, in one embodiment, is formed from a metal; however, inner member 500 may be formed from other suitable materials.

FIG. 6 is a flowchart demonstrating a hole misalignment compensation method in accordance with one embodiment of the present invention. Outer bushing 200 is disposed within hole 101 of structural part 100 at step 600. As described above, outer bushing 200 has outside diameter 204 approximately equal to a diameter of hole 101, and inside diameter 206 eccentric to outside diameter 204. Inner bushing 202 is disposed within outer bushing 200 at step 602. As described above, inner bushing 202 has outside diameter 210 approximately equal to inside diameter 206 of outer bushing 200, and inside diameter 212 eccentric to outside diameter 210. Outer bushing 200 and inner bushing 202 are rotated at step 604 such that axis 216 of inner diameter 212 approximately aligns with axis 300 of hole 103 in structural part 102, thereby completing one method of compensating for misalignment of hole 101 in structural part 100 and hole 103 and structural part 102. A fastener, such as a bolt, may then be inserted through inside diameter 212 and hole 103 to facilitate the joining of structural part 100 and structural part 102.

Although embodiments of the invention and their advantages are described in detail, a person skilled in the art could make various alternations, additions, and omissions without departing from the spirit and scope of the present invention as defined by the appended claims.

What is claimed is:

1. A system for compensating for misalignment of a first hole in a first part and a second hole in a second part, comprising:
an outer bushing having a first outside diameter approximately equal to a diameter of the first hole and a first inside diameter eccentric to the first outside diameter; and
an inner bushing having a second outside diameter approximately equal to the first inside diameter and a second inside diameter eccentric to the second outside diameter, the inner bushing adapted to be positioned such that an axis of the second inner diameter approximately aligns with an axis of the second hole.

2. The system of claim 1, wherein the eccentricity of the first inside diameter plus the eccentricity of the second inside diameter is no less than the misalignment of the first hole and the second hole.

3. The system of claim 1, wherein the inner bushing is adapted to be rotated such that the axis of the second inside diameter approximately aligns with the axis of the second hole.

4. The system of claim 1, wherein the outer bushing and the inner bushing are adapted to be rotated such that the axis of the second inside diameter approximately aligns with the axis of the second hole.

5. The system of claim 1, wherein the second inside diameter approximately equals the diameter of the second hole of the second part.

6. The system of claim 1, wherein the outer bushing and the inner bushing are adapted to be inserted into the first hole in the first part.

7. A system for compensating for misalignment of a first hole in a first part and a second hole in a second part, comprising:
an outer bushing having a first outside diameter approximately equal to a diameter of the first hole and a first inside diameter eccentric to the first outside diameter; and
an inner member having a first cylindrical portion with a diameter approximately equal to the first inside diameter and a second cylindrical portion eccentric to the first cylindrical portion, the inner member adapted to be positioned such that an axis of the second cylindrical portion approximately aligns with an axis of the second hole.

8. The system of claim 7, wherein the eccentricity of the first inside diameter plus the eccentricity of the second cylindrical portion is no less than the misalignment of the first hole and the second hole.

9. The system of claim 7, wherein the inner member is adapted to be rotated such that the axis of the second cylindrical portion approximately aligns with the axis of the second hole.

10. The system of claim 7, wherein the outer bushing and the inner member are adapted to be rotated such that the axis of the second cylindrical portion approximately aligns with the axis of the second hole.

11. The system of claim 7, wherein the second cylindrical portion has a diameter approximately equal to the diameter of the second hole of the second part.

12. The system of claim 7, wherein the outer bushing and the first cylindrical portion are adapted to be inserted into the first hole in the first part.

13. The system of claim 7, wherein the inner member includes a head coupled to the first cylindrical portion, an axis of the head substantially coaxial with the axis of the second cylindrical portion.

14. The system of claim 13, wherein at least a portion of the second cylindrical portion is formed with threads.

15. A method for compensating for misalignment of a first hole in a first part and a second hole in a second part, comprising:
disposing an outer bushing within the first hole of the first part, the outer bushing having a first outside diameter approximately equal to a diameter of the first hole and a first inside diameter eccentric to the first outside diameter;
disposing an inner bushing within the outer bushing, the inner bushing having a second outside diameter approximately equal to the first inside diameter and a second inside diameter eccentric to the second outside diameter; and
positioning the inner bushing such that an axis of the second inner diameter approximately aligns with an axis of the second hole.

16. The method of claim 15, wherein the eccentricity of the first inside diameter plus the eccentricity of the second inside diameter is no less than the misalignment of the first hole and the second hole.

17. The method of claim 15, wherein positioning the inner bushing comprises rotating the inner bushing such that the axis of the second inner diameter approximately aligns with the axis of the second hole.

18. The method of claim 15, wherein positioning the inner bushing comprises rotating the outer bushing and the inner bushing such that the axis of the second inner diameter approximately aligns with the axis of the second hole.

19. The method of claim 15, wherein the second inside diameter approximately equals the diameter of the second hole of the second part.

20. A method for compensating for misalignment of a first hole in a first part and a second hole in a second part, comprising:
disposing an outer bushing within the first hole of the first part, the outer bushing having a first outside diameter approximately equal to a diameter of the first hole and a first inside diameter eccentric to the first outside diameter;
disposing an inner member within the outer bushing, the inner member having a first cylindrical portion with a diameter approximately equal to the first inside diameter and a second cylindrical portion eccentric to the first cylindrical portion; and
positioning the inner member such that an axis of the second cylindrical portion approximately aligns with an axis of the second hole.

21. The method of claim 20, wherein the eccentricity of the first inside diameter plus the eccentricity of the second cylindrical portion is no less than the misalignment of the first hole and the second hole.

22. The method of claim 20, wherein positioning the inner member comprises rotating the inner member such that the axis of the second cylindrical portion approximately aligns with the axis of the second hole.

23. The method of claim 20, wherein positioning the inner member comprises rotating the outer bushing and the inner member such that the axis of the second cylindrical portion approximately aligns with the axis of the second hole.

24. The method of claim 20, wherein the second cylindrical portion has a diameter approximately equal to the diameter of the second hole of the second part.

25. The method of claim 20, further comprising providing a head with the first cylindrical portion, an axis of the head substantially coaxial with the axis of the second cylindrical portion.

26. The method of claim 25, further comprising providing the second cylindrical portion with threads.

27. A system for compensating for misalignment of a first hole in a first part and a second hole in a second part, comprising:
an outer member comprising a first cylindrical body having a longitudinal axis, the first cylindrical body having an outside diameter approximately equal to the diameter of the first hole in the first part;
a first cylindrical passage through the first cylindrical body, the first cylindrical passage having a longitudinal axis eccentric to the longitudinal axis of the first cylindrical body;
an inner member comprising a second cylindrical body having a longitudinal axis, the second cylindrical body having an outside diameter approximately equal to the diameter of the first cylindrical passage, the second cylindrical body rotationally engaged with the first cylindrical body; and
a second cylindrical passage through the second cylindrical body, the second cylindrical passage having a longitudinal axis eccentric to the longitudinal axis of the second cylindrical body.

28. The system of claim 27, wherein the eccentricity of the longitudinal axis of the first cylindrical passage plus the eccentricity of the longitudinal axis of the second cylindrical passage is no less than the misalignment of the first hole and the second hole.

29. The system of claim 27, wherein the first cylindrical body and the second cylindrical body are adapted to be rotated such that the longitudinal axis of the second cylindrical passage substantially aligns with a longitudinal axis of the second hole of the second part.

30. The system of claim 27, wherein the diameter of the second cylindrical passage approximately equals the diameter of the second hole of the second part.
